(19) United States
(12) Patent Application Publication
(10) Pub. No.: US 2003/0147103 A1
(43) Pub. Date: Aug. 7, 2003

(54) Mechanical switching apparatus for resolution adjustment

(76) Inventor: Kuang Hui Hung, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/062,765

(22) Filed: Feb. 5, 2002

(51) Int. Cl. H04N 1/04

(52) U.S. Cl. 358/474

(57) ABSTRACT

A mechanical switching apparatus for resolution adjustment comprises a case and a switch arranged within the case and having a portion exposed out of the case. The exposed portion of the switch is slidable within an opening formed on the case. The switch has a first clamping arm and a second clamping arm extending therefrom. The first clamping arm has a light emitter thereon and the second clamping arm has a light receiver thereon. At least two slits sets with different slit number are provided between the light emitter and the light receiver and the switch switching the light emitter and the light receiver between the slit sets for achieving different resolution. The slit sets are arranged on single or multiple rotational plates simultaneously rotated with a canning carriage.

### FIELD OF THE INVENTION

The present invention relates to a mechanical switching apparatus for resolution adjustment, especially to a mechanical switching apparatus for resolution adjustment of a scanner.

### BACKGROUND OF THE INVENTION

The conventional scanners such as flatbed scanners, hand-held scanners or pen scanners generally comprise carriages with various sizes. The carriage comprises a contact image sensor (CIS) and has generally different scanning region. Therefore, the carriage can be used to scan a document by one or more scanning strokes. FIG. 1 shows a hand-held scanner with unique resolution. The hand-held scanner has a case 1 and a window 11 at left bottom side of the case 1. A contact wheel 12 protrudes through the window 11 and is in contact with the document to be scanned. The contact wheel 12 has a carriage 13 facing the window 11. The contact wheel 12 is linked with a rotational plate 15 through a gear set 14. The rotational plate 15 has a plurality of lobed slits thereon and two optoelectronic elements 17 on both sides thereof. One optoelectronic element 17 is a light emitter and another optoelectronic element 17 on opposite side is a light receiver. The rotational plate 15 shown in FIG. 1 has three, for example, lobed slits. In generally, the hand-held scanner is preferably to have wide range of resolution for different applications. If users want to change the resolution of the hand-held scanner, they have to change rotational plate 15 with different slit numbers or buy another scanner of higher resolution. However, it is high cost and not convenient for normal users.

Moreover the resolution can be adjusted by using step motor in conjunction with associated software and firmware or post treatment by image processing software. However, the step motor has complicated structure and high cost. Moreover, the post treatment by image processing software is cumbersome and may not be of fidelity.

### SUMMARY OF THE INVENTION

It is the object of the present invention to provide a mechanical switching apparatus for resolution adjustment, by which a scanner can be switched to various resolutions manually. Therefore, the software post treatment step may be saved.

To achieve above object, the present invention provides a mechanical switching apparatus for resolution adjustment, which comprises a case and a switch arranged within the case and having a portion exposed out of the case. The exposed portion of the switch is slidable within an opening formed on the case. The switch has a first clamping arm and a second clamping arm extending therefrom. The first clamping arm has a light emitter thereon and the second clamping arm has a light receiver thereon. At least two slits sets with different slit number are provided between the light emitter and the light receiver and the switch switches the light emitter and the light receiver between the slit sets for achieving different resolution. The slit sets are arranged on single or multiple rotational plates simultaneously rotated with a scanning carriage.

The various objects and advantages of the present invention will be more readily understood from the following detailed description when read in conjunction with the appended drawing, in which:

### BRIEF DESCRIPTION OF DRAWING

FIG. 1 shows a conventional scanner with unique resolution;

FIG. 2 shows a perspective view of the present invention;

FIG. 3 shows a sectional view of the first preferred embodiment in low-resolution mode;

FIG. 4 shows another sectional view of the first preferred embodiment in low-resolution mode;

FIG. 5 shows a sectional view of the first preferred embodiment in high-resolution mode;

FIG. 6 shows another sectional view of the first preferred embodiment in high-resolution mode; and

FIG. 7 shows a sectional view of the second preferred embodiment in low-resolution mode.

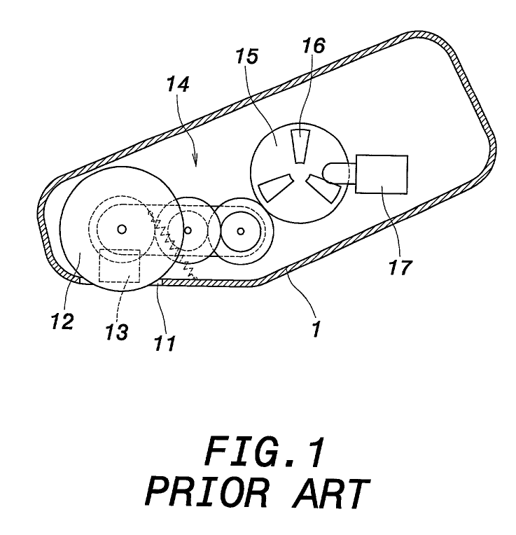

### DETAILED DESCRIPTION OF THE INVENTION

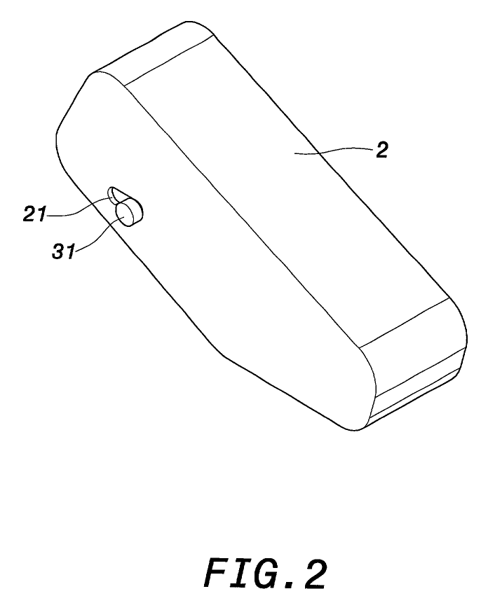

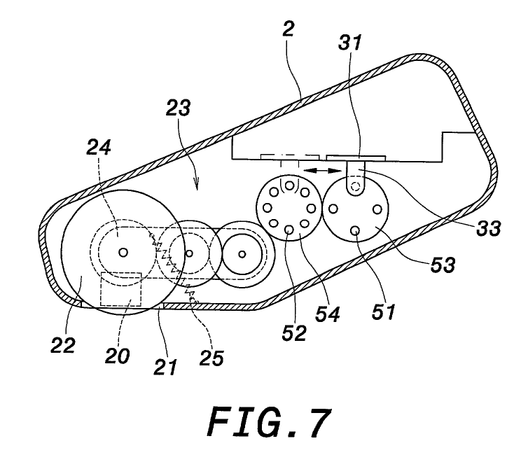

FIGS. 2 to 6 show the mechanical switching apparatus for resolution adjustment according to the first preferred embodiment of the present invention. The mechanical switching apparatus for resolution adjustment mainly comprises a case 2 and a switch 3 with most part received in the case 2. The switch 3 has a head 31 exposed out of the case 2 and a neck 32 slidable along an opening 26 formed on the case 2. The switch 3 has a first clamping arm 33 and a second clamping arm 34 extending therefrom. The first clamping arm 33 has a light emitter 41 thereon and the second clamping arm 34 has a light receiver 42 thereon. The switch 3 can be switched between at least two different slit sets 51 and 52 to achieve different resolution. The different slit sets 51 and 52 can be arranged on the same rotational plate 5, or different rotational plates 53, 54 as shown in FIG. 7, wherein the rotational plates 5, 53 and 54 rotate synchronously with a scanning carriage 20.

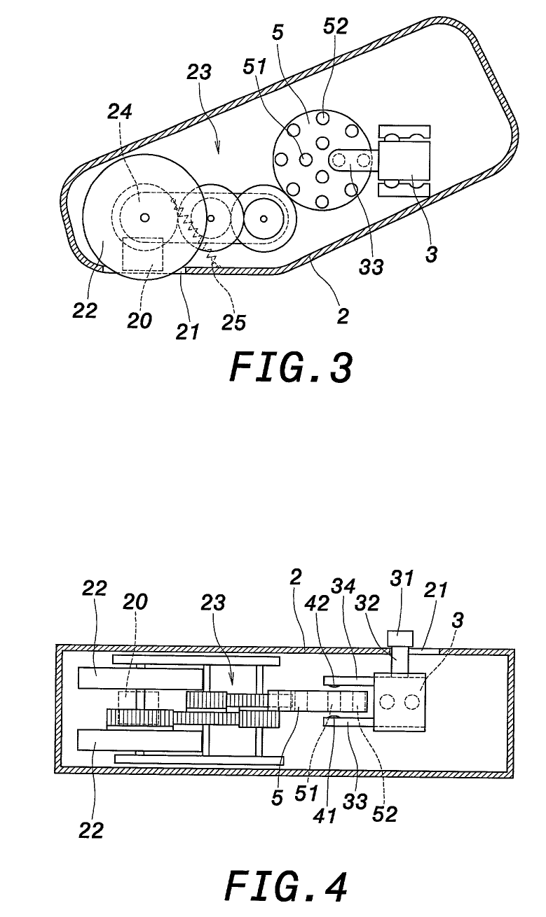

As shown in FIG. 3, the case 2 has a window 21 at left bottom side thereof. A contact wheel 22 protrudes through the window 21 and is in contact with the document to be scanned. The contact wheel 22 has a scanning carriage 20 facing the window 21. The contact wheel 22 is linked with a rotational plate 5 through a gear set 23.

The rotational plate 5 has a plurality of first slits 51 and second slits 52 arranged radially. The contact wheel 22 is connected to a swing arm 24 and the swing arm 24 is connected to a spring 25 such that the contact wheel 22 can be kept in contact with the document. The gear set 23 is composed of a pair of gears and enable the synchronous rotation of the rotational plate 5. In the first preferred embodiment, the rotational plate 5 has a first slit set 51 with four slits and used for low-resolution scanning, and a second slit set 52 with eight slits and used for high-resolution scanning.

FIGS. 3 and 4 depict the operation of low-resolution scanning; wherein the light emitted from the light emitter 41 passes through the slit set with smaller slit number and is then received by the light receiver 42.

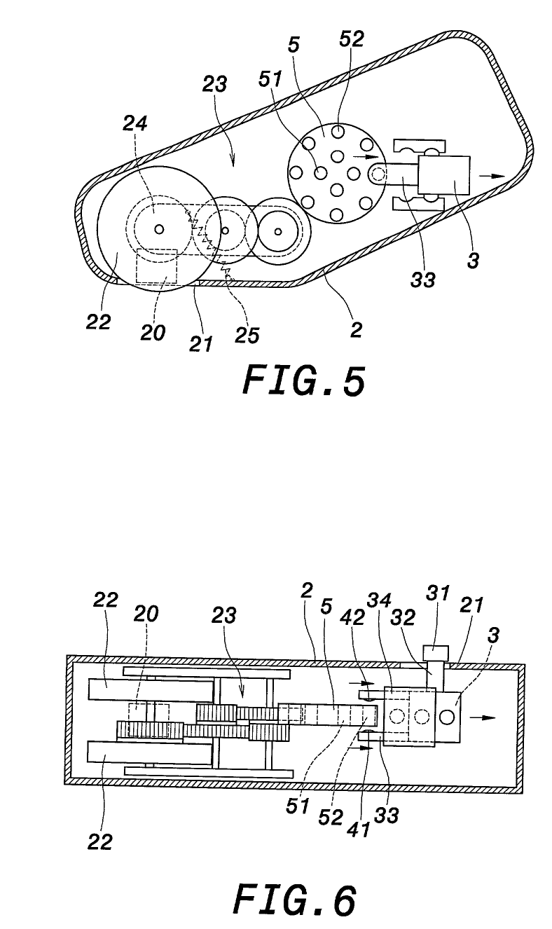

FIGS. 5 and 6 depict the operation of high-resolution scanning; wherein the light emitted from the light emitter 41 passes through the slit set with larger slit number and is then received by the light receiver 42.

Therefore, by toggling the switch 3, the sensor set (the light emitter 41 and the light receiver 42) is moved from the proximity of the first slit set 51 to the proximity of the second slit set 52. The light passes through an 8-slit passage instead of a 4-sit passage and the resolution is doubled. For example, if the original resolution is 600 dpi, the switch operation enhances the resolution to 1200 dpi. Moreover, the first slit set 51 and the second slit set 52 are rotated in concentric way, the occurrence rate of slit is increased when the sensor set is moved from the position shown in FIG. 3 to the position shown in FIG. 5. On the contrary, the occurrence rate of slit is decreased when the sensor set is moved from the position shown in FIG. 5 to the position shown in FIG. 3. FIGS. 4 and 6 shows the respective positions of the light emitter 41 and the light receiver 42 in each case. Moreover, the number of slit set can be more than 2 to provide more flexible resolution.

FIG. 7 shows the mechanical switching apparatus for resolution adjustment according to the second preferred embodiment of the present invention. The mechanical switching apparatus shown in this figure has similar components as that in the first preferred embodiment except that the first slit set 51 is arranged on a first rotational plate 53 and the second slit set 52 is arranged on a second rotational plate 54. Moreover, the second rotational plate 54 is connected to the gear set 23 and the first rotational plate 53 is connected to the second rotational plate 54. The first rotational plate 53 and the second rotational plate 54 have the same size and rotation speed, and different slit number. Therefore, the first rotational plate 53 and the second rotational plate 54 provide different resolutions. As shown in this figure, various resolutions can be provided by preparing a plurality of rotational plates with different slit number, wherein the high-resolution case is indicated by solid line and the low-resolution case is indicated by dashed line.

To sum up, the mechanical switching apparatus for resolution adjustment according to the present invention has a switch linked to an optoelectronic sensor set. The switch can switch the optoelectronic sensor set to positions with different slit number corresponding to various resolution. Moreover, the different slit number can be achieved by single rotational plate or multiple rotational plates. The mechanical switching apparatus according to the present invention has the advantages of low cost, simple structure and low power consumption. Moreover, the switching apparatus is operated in a mechanical way, which is more robust and convenient than software post treatment.

Although the present invention has been described with reference to the preferred embodiment thereof, it will be understood that the invention is not limited to the details thereof. Various substitutions and modifications have suggested in the foregoing description, and other will occur to those of ordinary skill in the art. For example, the switch is a mechanical switch, which can be a toggle switch, a button switch, a rotary switch, or a slide switch. Therefore, all such substitutions and modifications are intended to be embraced within the scope of the invention as defined in the appended claims.

I claim

1. A mechanical switching apparatus for resolution adjustment, comprising
a case; and
a switch arranged within the case and having a portion exposed out of the case, the switch having a first clamping arm and a second clamping arm extending therefrom, the first clamping arm having a light emitter thereon and the second clamping arm having a light receiver thereon, at least two slits sets with different slit number being provided between the light emitter and the light receiver and the switch switching the light emitter and the light receiver between the slit sets for achieving different resolution.

2. The mechanical switching apparatus for resolution adjustment as in claim 1, wherein the slits sets are arranged in a rotational plate in concentric fashion.

3. The mechanical switching apparatus for resolution adjustment as in claim 1, wherein the slits sets are arranged in multiple rotational plates linked to each other.

4. The mechanical switching apparatus for resolution adjustment as in claim 1, wherein the switch is one of a toggle switch, a button switch, a rotary switch, and a slide switch.
